(19) United States
(12) Patent Application Publication
(10) Pub. No.: US 2013/0157834 A1
(43) Pub. Date: Jun. 20, 2013

(54) COMPOSITE DISPOSABLE CENTRIFUGE ROTOR WITH REUSABLE METAL CENTERTUBE

(71) Applicant: Cummins Filtration IP, Inc., Minneapolis, MN (US)

(72) Inventors: Carey A. CURT, Cookeville, TN (US); Philip S. HALL, Cookeville, TN (US)

(73) Assignee: CUMMINS FILTRATION IP, INC., Minneapolis, MN (US)

(21) Appl. No.: 13/717,924

(22) Filed: Dec. 18, 2012

Related U.S. Application Data
(60) Provisional application No. 61/577,785, filed on Dec. 20, 2011.

(51) Int. Cl. B04B 7/08

(52) U.S. Cl. CPC B04B 7/08
USPC 494/38; 494/43

(57) ABSTRACT

A hybrid metal/composite centrifuge is described which can be designed and manufactured for large sizes which have traditionally been of metal construction only. The hybrid metal/composite centrifuge combines an “all composite”, fully disposable, centrifuge rotor with a reusable metal center tube which retains the rotor bearings. This design combines a fully disposable composite rotor, for example made of an incinerable plastic material, with a removable and reusable metal centertube.

### FIELD

A composite, disposable centrifuge rotor that is useable in a centrifuge filtration system is described.

### BACKGROUND

Centrifuge filtration systems for filtering fluids, such as lube oil, are known. These devices generally include a centrifuge rotor formed by an outer rotor shell sealed to a rotor base, and a centertube that extends between a center of the rotor base and a center of the rotor shell. Some centrifuge designs do not have a centertube. The centrifuge rotor is rotatably disposed on a shaft for rotation relative to the shaft.

The market for a large diameter centrifuge rotor is dominated by very expensive “all metal” designs due to the mechanical stress limits inherent in composite centrifuge rotors which would not normally have the strength to survive heavy duty requirements. Currently there are size limitations to the use of a fully composite centrifuge rotor. Among these limitations are performance characteristics, holding capacity and material cost. As the size requirement increases beyond these limitations, the typical material choice for key components of a rotor is metal which adds cost to the manufacturing process. The result is an expensive, heavy, non-disposable rotor with significant maintenance activity required at regular service intervals.

Centrifuge designs are known that utilize a metal centertube which retains the bearings. However, in these designs, the rotors are all metal.

An all composite, incinerable insert cartridge that is installable in a metal rotor is known from the CS44000 ConeStaC™ centrifuge insert cartridge available from Cummins Filtration. However, the CS44000 is not a pressure vessel. Rather, it is just an incinerable service component that is held within a metal rotor shell and metal centertube/baseplate assembly.

### SUMMARY

A hybrid metal/composite centrifuge rotor is described which can be designed and manufactured for large sizes which have traditionally been of metal construction only. The rotor is useable in a centrifuge filtration system for filtering a fluid including, but not limited to, lube oil.

In one embodiment, the hybrid metal/composite centrifuge combines an “all composite”, fully disposable, large diameter centrifuge rotor with a reusable metal centertube which retains the rotor bearings. This design combines a fully disposable composite rotor, for example made of an incinerable plastic material, with a generally permanent, reusable metal centertube which provides greater resistance to internal pressure when compared to a composite only centrifuge rotor. The employment of a metal centertube to provide support adds strength to a composite rotor and provides a lower cost, disposable alternative to large diameter centrifuges that utilize “all metal” rotors.

In one embodiment, a centrifuge includes a composite rotor made entirely from incinerable material, where the rotor includes a first opening at one end and a second opening at an opposite end. A metal centertube supports the composite rotor, and includes a first end that extends through the first opening of the rotor and a second end that extends through the second opening of the rotor. A first bearing is mounted on the centertube at the first end thereof and a second bearing is mounted on the centertube at the second end thereof for rotatably supporting the metal centertube, and the centertube is removably mounted on the rotor.

The composite rotor can be used in place of a higher cost, higher maintenance rotor and is able to withstand pressure load distributions present in a large diameter centrifuge.

The reusable metal centertube assembly provides a “backbone” for the composite rotor and has bearings mounted thereon instead of on the rotor to allow for a fully disposable, fully incinerable centrifuge rotor.

### DRAWINGS

FIG. 1 is an exploded view of components of the hybrid metal/composite centrifuge along with a shaft.

FIG. 2 is a cross-sectional view of the composite rotor with the metal centertube installed.

FIG. 3 is a cross-sectional view of the composite rotor with the metal centertube removed.

FIG. 4 is a perspective view of the metal centertube assembly used to support the composite rotor.

### DESCRIPTION

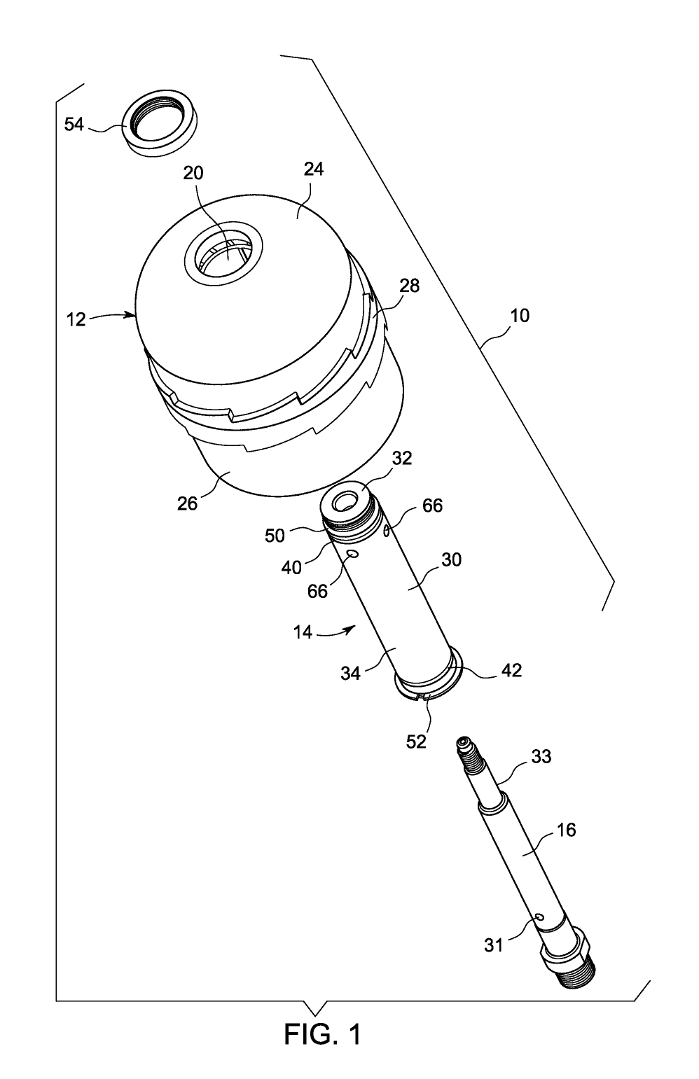

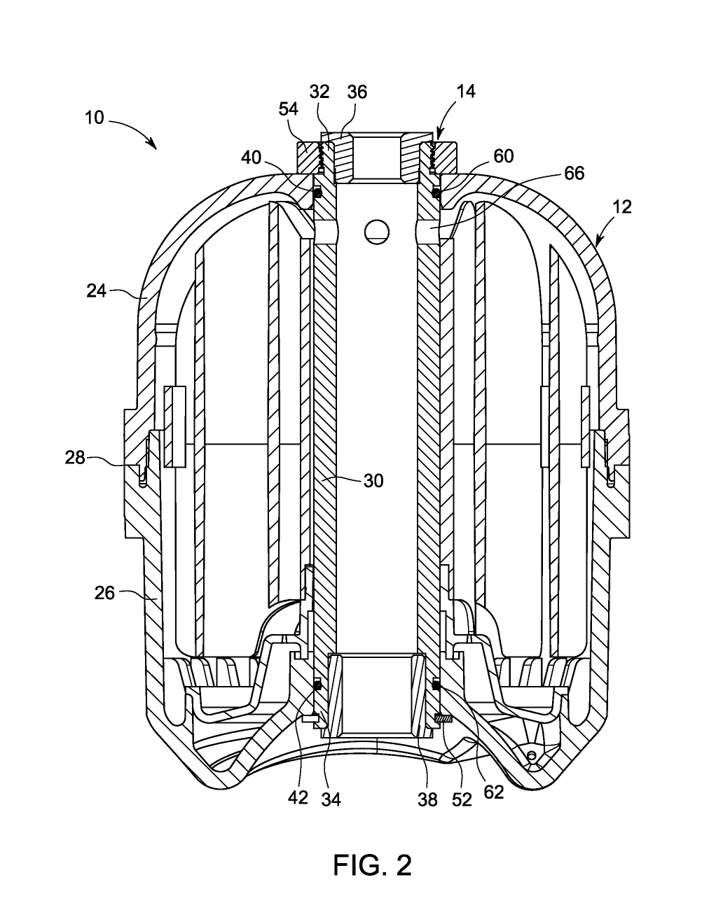

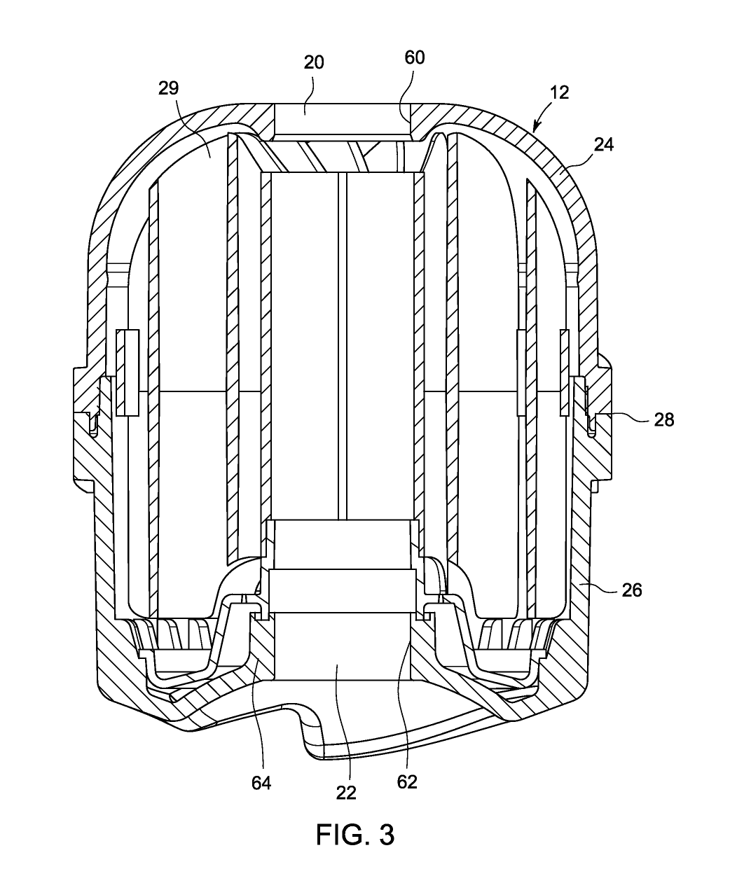

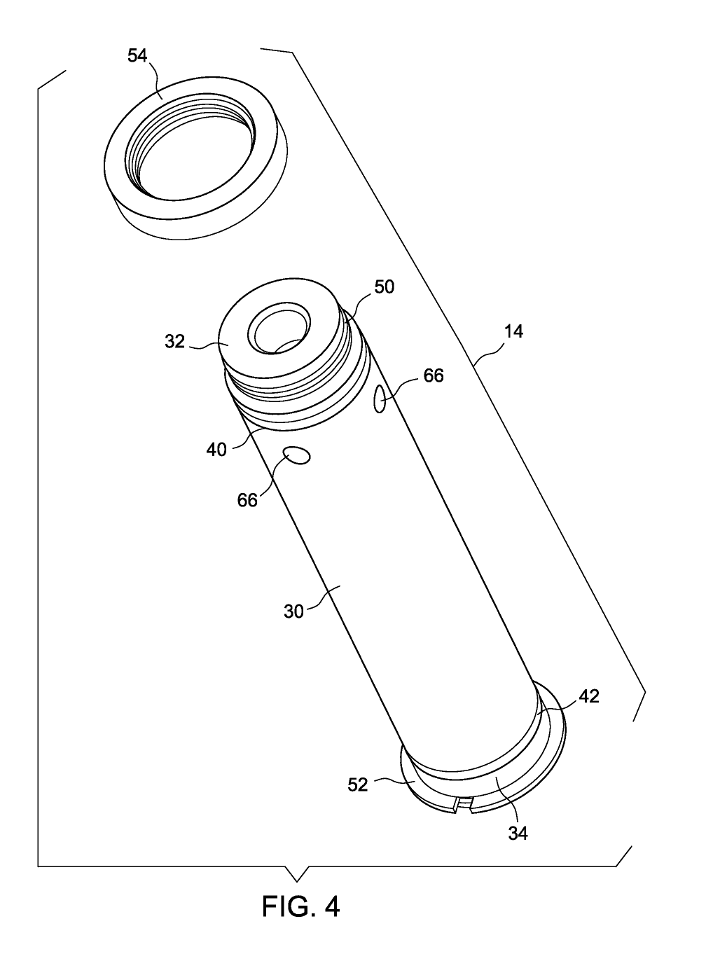

With reference to FIGS. 1-4, the hybrid metal/composite centrifuge 10 includes a composite rotor 12 and a centertube assembly 14. In use, the centrifuge 10 can be rotatably mounted on a shaft 16 for rotation relative to the shaft.

The composite rotor 12 is an all incinerable construction that allows the rotor to be incinerated for disposal. The rotor 12 can be made of any suitable incinerable material, such as an incinerable plastic. The rotor 12 includes a first opening 20 at one end and a second opening 22 at an opposite end for receipt of the centertube of the centertube assembly.

In the illustrated example, the rotor 12 includes an upper, outer rotor shell 24 that is sealed along a base edge thereof to a lower rotor base 26 along a seam 28. The outer rotor shell 24 and the lower rotor base 26 rotate together and define an interior space 29 in which the centrifugal separation occurs. The first opening 20 is formed centrally in the outer shell 24 while the second opening 22 is formed centrally in the lower base 26 coaxial to the first opening.

The shell 24 and the base 26 essentially form a pressure containment vessel during use. The shell 24 and the base 26 can be formed with features to achieve separation of contaminants from the fluid being filtered. For example, in the case of lube oil that is to be filtered, the shell 24 and the base 26 can include jet drive features to cause rotation of the rotor 12 to effect the separation. The construction and operation of features in centrifuge rotors to achieve separation of contaminants from the fluid are well known to those of ordinary skill in the art. Examples of centrifuge rotors are disclosed in, for example, U.S. Pat. Nos. 7,674,376 and 7,566,294.

The centertube assembly 14 includes a metal centertube 30 having a first end 32 that in use extends through the first opening 20 and a second end 34 that in use extends through the second opening 22. A first bearing 36 is mounted on the centertube 30 at the first end and a second bearing 38 is mounted on the centertube at the second end for rotatably supporting the metal centertube on the shaft 16 for rotation about the axis of the shaft.

A suitable radial seal 40, 42, for example an elastomeric o-ring, x-ring, x-rings, a wiper seal, or the like, is mounted on the centertube 30 at each of the first end 32 and the second end 34, with the radial seals sealing with respective sealing surfaces 60, 62 on the rotor to seal between the centertube and the rotor. The sealing surface 60 is defined by a circumferential shoulder on the shell 24 that defines the first opening 20. The sealing surface 62 is defined by a circumferential wall 64 that extends upwardly from the base 26 in a direction toward the first opening 20 and that defines the second opening 22.

The centertube 30 is generally hollow to allow passage of the shaft 16. Openings 66 are formed in the centertube to allow fluid to flow from the interior space 29 into the interior of the centertube 30, and then through flow passages 31 formed in the shaft 16. The openings 66 are located on the centertube 30 between the seals 40, 42, for example closer to the seal 40 than to the seal 42. In the illustrated example, the openings 66 are located on the centertube 30 at a location just beneath the seal 40, and are located at a step-down region 33 of the shaft 16 where the outer perimeter of the shaft 16 is reduced. Although the shaft 16 is illustrated as being circular when taken in cross-section, the shaft 16 can have any shape including, but not limited to, square, octagonal, oval, etc.

In addition, the centertube 30 is illustrated as being cylindrical with a circular outer and inner perimeter, and being substantially hollow. However, the inner perimeter of the centertube 30 can have any shape that allows the shaft 16 to fit therethrough, including generally matching the shape of the shaft 16. Further, the outer perimeter of the centertube 30 can have any shape including, but not limited to, square, octagonal, oval, etc. Likewise, the openings 20, 22 are illustrated as being circular, but they can have any shape, such as square, octagonal, oval, etc., that allow passage of and sealing with the centertube 30.

The centertube 30 is removably mounted on the rotor 12 to allow it to be reused. In particular, the first end 32 of the centertube is threaded 50. A retainer clip 52 is mounted on the centertube at the second end 34, and a threaded collar 54 is engaged with the threads 50 at the first end 32 that in use removably clamps the rotor 12 on the centertube 30 between the threaded collar and the retainer ring. At the same time, the seals 40, 42 seal with the sealing surfaces 60, 62 so that the rotor 12 forms a pressure containment vessel.

The reusable centertube 30 contains the bearings 36, 38, for example bushings, which can be made from a low cost, drawn metal tubing construction. In contrast, the rotor 12 is constructed from fully composite components that can be incinerated. The rotor can have any conventional features including, but not limited to, jet drive features in centrifuges available from Cummins Filtration, Inc.

The hybrid centrifuge 10 is different because the bearings are no longer held in the separable composite rotor 12. This difference helps to make the rotor 12 fully disposable and incinerable upon removal. Further, the inclusion of radial seals between the centertube 30 and the composite rotor 12 enables pressure containment while still allowing for easy disassembly.

The shaft 16 and centertube 30 are illustrated as full flow designs. However, the shaft and centertube could be designed to implement split flow where the percentage of flow entering the collection chamber relative to the percentage of flow bypassing the collection and going to jet drive nozzles is controlled as described in U.S. Pat. No. 7,377,893.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A centrifuge comprising:
a composite rotor made entirely from incinerable material, the rotor includes a first opening at one end and a second opening at an opposite end; and
a metal centertube that supports the composite rotor, the metal centertube includes a first end that extends through the first opening and a second end that extends through the second opening; a first bearing mounted on the centertube at the first end and a second bearing mounted on the centertube at the second end for rotatably supporting the metal centertube, and the centertube is removably mounted on the rotor.

2. The centrifuge of claim 1, comprising a radial seal mounted on the centertube at each of the first end and the second end, the radial seals sealing between the centertube and the rotor.

3. The centrifuge of claim 1, wherein the first end of the centertube is threaded, a retainer clip is mounted on the centertube at the second end, and a threaded collar is engaged with the threaded first end that removably clamps the rotor on the centertube between the threaded collar and the retainer clip.

4. A centrifuge comprising:
a composite rotor made entirely from incinerable material, the rotor includes an upper, outer rotor shell that is sealed along a base edge thereof to a lower rotor base along a seam to define an interior space in which centrifugal separation occurs;
a first opening is formed centrally in the outer rotor shell and a second opening is formed centrally in the lower rotor base opposite the first opening; and
a metal centertube that supports the composite rotor, the metal centertube includes a first end that extends through the first opening and a second end that extends through the second opening; a first bearing mounted on the centertube at the first end and a second bearing mounted on the centertube at the second end for rotatably supporting the metal centertube, and the centertube is removably mounted on the rotor.

5. The centrifuge of claim 4, comprising a radial seal mounted on the centertube at each of the first end and the second end, the radial seals sealing between the centertube and the rotor.

6. The centrifuge of claim 4, wherein the first end of the centertube is threaded, a retainer clip is mounted on the centertube at the second end, and a threaded collar is engaged with the threaded first end that removably clamps the rotor on the centertube between the threaded collar and the retainer clip.
